(19) United States
(12) Patent Application Publication
(10) Pub. No.: US 2023/0371532 A1
(43) Pub. Date: Nov. 23, 2023

(54) Method and Apparatus for Weakening Pin Bone Attachment in Fish

(71) Applicant: Circle Seafoods, Inc., Portland, OR (US)

(72) Inventor: Gene Patrick Glaab, Sitka, AK (US)

(21) Appl. No.: 18/226,707

(22) Filed: Jul. 26, 2023

Related U.S. Application Data
(63) Continuation-in-part of application No. 18/118,051, filed on Mar. 6, 2023.
(60) Provisional application No. 63/318,728, filed on Mar. 10, 2022.

(51) Int. Cl. A22C 25/16

(52) U.S. Cl. CPC A22C 25/166

(57) ABSTRACT

An apparatus for weakening an attachment of a pin bone to muscle or adipose tissue in a fillet of fish, comprising an energy source to supply sufficient heat to substantially only the pin bone and connective tissue that attaches the pin bone to the muscle or adipose tissue in the fillet of fish to degrade or denature the connective tissue without degrading or denaturing the muscle or adipose tissue and thereby weaken the attachment of the pin bone to the muscle or adipose tissue in the fillet of fish.

### CROSS-REFERENCE TO RELATED APPLICATIONS

This Continuation-In-Part application claims priority to U.S. Non-Provisional application Ser. No. 18/118,051, filed Mar. 6, 2023, entitled “METHOD AND APPARATUS FOR WEAKING PIN BONE ATTACHMENT IN FISH”, and claims the benefit of U.S. Provisional Application No. 63/318,728, filed Mar. 10, 2022. The entire contents of both applications are hereby incorporated by reference herein.

### TECHNICAL FIELD

Embodiments of the present invention relate to loosening or weakening the attachment of pins bones in a fillet of fish to make subsequent removal of the pin bones easier, faster, and with less damage to the fillet of fish.

### BACKGROUND

When disassembling a fish for a fresh fish purchase, removing bone structure is a relatively straight forward and satisfactory process for everything except the pin bones. The pin bones are not only a market red line for their small size and inconvenience to negotiate on a plate, but also present a considerable choking hazard with the legal liability that one would expect. The pin bones run generally diagonally down the center line of a fillet of fish and are spaced very close together (e.g., spaced a few millimeters apart) making them very hard to remove by the stroke of a knife. As a result, markets have all but eliminated splitting the fillet in half as a recourse.

The current solution, employed almost universally, works only on “relaxed” fish. A “relaxed” fish is an industry term coined to describe a fish that is allowed to deteriorate or metabolically decompose to the point of complete or at least sufficient breakdown of the connective tissue between the pin bones and the muscle or adipose tissue of the fillet of fish allowing the pin bones to be pulled with less effort, if not effortlessly, and with little or no tearing of the delicate flesh surrounding them. This is far from a desirable state in a fish for any other reason than to pull the pin bones. Unfortunately for consumers, processors rarely need to induce this state as it is a natural occurrence associated with the poor handling practices that are endemic and nearly universal in the industry.

Currently there are three main ways the fish industry deals with this problem: 1) cut pin bones out by hand with a knife or a machine. This leaves the fillet split down the center wasting a considerable amount of flesh which is very expensive; 2) pulling the pin bones by hand with a pair of pliers, a difficult and cost prohibitive method; 3) a pin bone removal machine utilized as a distinct step in a processing line. The fillet is loaded and roughly indexed onto a soft, flexible belted conveyor. The conveyor runs the individual fillet under a floating and rotating pin bone removal wheel and plate assembly. The removal wheel incorporates sharp edged lineal teeth that run parallel to the axis of rotation. The conveyor belt may be run over a slight hump or bend in the deck just below the removal wheel to bend the fillet backwards and to expose approx. ⅛″ of pin bone above the inside surface of the fillet. As the fillet travels past the wheel, the wheel pinches the end of the bone between its teeth and a thin plate that is statically resting on top of the fillet directly below the wheel. The rotary motion of the wheel pulls and walks the bone away from the fillet as it turns. By this process, if the pin bone is still meaningfully attached, it either resists removal and slips between the wheel and blade and remains a choking hazard in the fillet, or the pin bone drags the flesh attached to the pin bone into the wheel tearing a trough down the center of the fillet. This is currently the industry standard solution.

The novel process described herein solves this conundrum by purposely and accurately denaturing, i.e., altering, the membrane or connective tissue attaching the pin bone to the flesh, without substantially affecting the flesh surrounding it. In short, this novel process allows subsequent damage-free pin bone removal on a fresh fish, as opposed to a relaxed fish.

### BRIEF DESCRIPTION OF THE DRAWINGS

Embodiments are illustrated by way of example, and not by way of limitation, and can be more fully understood with reference to the following detailed description when considered in connection with the figures in which:

FIGS. 1A, 1B and 1C illustrate pin bones in a fillet of fish.

FIGS. 2A and 2B illustrate pin bone locations in different types of fish.

FIG. 3 illustrates an embodiment of the invention.

FIG. 4 illustrates an embodiment of the invention.

### DETAILED DESCRIPTION

The membrane between the bone and flesh in a finfish can be measured in microns and, among its many reasons for existence, is the primary carrier of electrical impulses from the skin to the spinal cord. In essence, the pin bone is a distinct and isolated corridor or conduit through the flesh of the fish.

When passing an electrical current through a conductor, heat is created through resistance (expressed as Ohms) and follows a fundamental mathematical formula (Ohm's law). This formula allows for extremely precise control over the placement and intensity of specific amounts of heat. Finfish proteins are very susceptible to temperature denaturing. It is understood that they generally breakdown at temperatures as low as 120 degrees Fahrenheit. Therefore, according to embodiments of the invention, heat can be used to denature the sheath membrane of a pin-bone, essentially rendering the connective tissue into a lubricant, and due to the low mass and surgical application of heat, does not meaningfully affect (in terms of heating or denaturing) the surrounding flesh.

Embodiments of the invention weaken an attachment of a pin bone to muscle or adipose tissue in a fresh fillet of fish. One embodiment of the invention involves a power supply that supplies electrical current. An electrode coupled to the power supply is brought into electrical contact with a first end of the pin bone, on an inside surface of the fresh fillet of fish, to conduct electrical current from the power supply to the pin bone. The pin bone conducts the electrical current from the first end of the pin bone to a second end of the pin bone, nearer the outside surface, or skin, of the fresh fillet of fish, and has an electrical current resistivity which causes Joule heating (also known as resistive, resistance, or Ohmic heating), essentially causing the pin bone to be a heating element. The Joule heating produces sufficient heat in the pin bone, and thus, in the connective tissue that attaches the pin bone to the muscle or adipose tissue in the fillet of fish to degrade or denature the connective tissue and thereby weaken the attachment of the pin bone to the muscle or adipose tissue in the fillet of fish. A grounding electrode is coupled to the power supply and is brought into electrical contact with, for example, the outside surface, or skin, of the fillet of fish to return the electrical current to the power supply or to ground.

According to the embodiment, the electrical current supplied to the pin bone is regulated to follow the sheath and heat the sheath to its denature point in a very focused and precise manner. The electrode has a very specific and adjustable charge profile to accommodate variations in the size and ultimately conductivity of the pin bones in the fillet. The charge profile can be adjusted either manually or through a feedback loop to improve the effectiveness of the process.

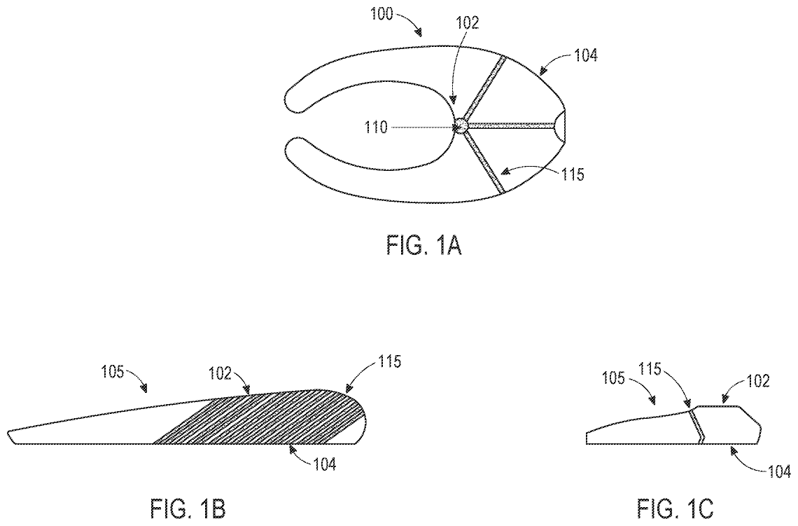

An embodiment of the invention described herein with reference to FIGS. 1A-1C takes advantage of the fact that the pin bone 115 has an electrical current resistivity. When the pin bone is used as an electrical current conductor, such as when an electric current is passed through the pin bone, Joule heating occurs in the pin bone. Joule heating is the process by which the passage of an electric current through a conductor produces heat, which is also known as resistive, resistance, or Ohmic, heating. The conversion of electricity to heat in the pin bone 115, by virtue of its electrical resistance, allows the pin bone 115 to be used essentially as a heating element, according to embodiments of the invention. The Joule heating produces sufficient heat in the connective tissue that attaches the pin bone 115 to the muscle or adipose tissue in the fillet of fish 105 to degrade or denature the connective tissue and thereby weaken the attachment of the pin bone 115 to the muscle or adipose tissue in the fillet of fish 105. Importantly, the heat is substantially contained within the pin bone and connective tissue immediately surrounding the pin bone and does not extend beyond these structures into the muscle or adipose tissue of the fish, so that there is no degrading or denaturing of the muscle or adipose tissue in the fish.

Other embodiments may involve the use of other or additional methods and apparatus to heat the pin bone 115. The key or common aspect of each embodiment is providing sufficient heat in the connective tissue that attaches the pin bone 115 to the muscle or adipose tissue in the fillet of fish 105 to degrade or denature the connective tissue and thereby weaken the attachment of the pin bone 115 to the muscle or adipose tissue in the fillet of fish 105, while at the same time substantially containing the heat to within the pin bone and connective tissue immediately surrounding the pin bone so that the heat does not extend beyond these structures into the muscle or adipose tissue of the fish and cause unwanted degrading or denaturing of the muscle or adipose tissue in the fish.

Such other embodiments include the use of an energy source that focuses, pinpoints, targets, generates, or sends heat into the pin bone and connective tissue immediately surrounding the pin bone and avoids heat extending into the muscle or adipose tissue adjacent the pin bone and connective tissue in the fish. One such energy source is microwave. Other sources of energy contemplated according to embodiments of the invention include but are not limited to audio waves, X-rays, laser, tailored photon bombardment, neutron bombardment.

As a result of these novel methods and apparatuses, little to no heating, denaturing or degradation occurs in the fillet of fish, whether on the fillet surface, or in the muscle or adipose tissue located near the pin bones. Furthermore, the subsequent pin bone removal can be performed on a fresh fillet of fish with little or minimal damage or tearing of the muscle or adipose tissue surrounding the pin bone.

FIG. 1A illustrates a cross-sectional view of a salmon (Salmo salar ) fish 100. A backbone 110 extends down the length of the fish. Pin bones 115 attach and extend substantially diagonally from the backbone through the fish, from an inside surface 102 of the fish's flesh to an outside, or skin, surface 104 of the fish. FIGS. 1B and 1C illustrate top and end views, respectively, of one of the two fillets of fish 105 after the backbone has been removed and the fish split into two fillets. Pin bones 115 generally extend from the inside surface 102 to the outside, or skin, surface 104 of the fillet 105. As can be seen in FIG. 1B, the pin bones 115 where they attach to the vertebra may be exposed, just above, or may be hidden, just at or below the inside surface of the fillet, such that one could see the ends of the pin bones exposed at the inner surface 102, and if one were to, say, run a finger down the thickest part of the fillet, they could feel the end of the pin bones at, or just extending above, the inner surface of the fillet.

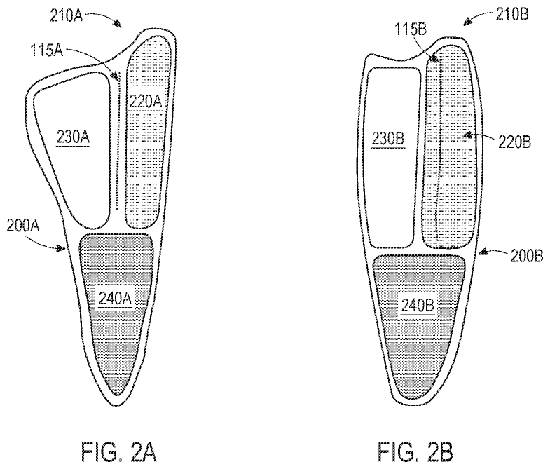

FIG. 2A illustrates pin bone locations in a cod (Gadus morhua) fillet 200A. The pin bones 115A, approximately 17 total, are positioned between the belly 230A and the loin 220A, extending in a straight line from the anterior or foremost portion of the fish fillet (i.e., from the neck 210A) to the posterior or hindmost portion and ending before the tail 240A of the fish fillet. FIG. 2B illustrates pin bone locations in salmon fillets 200B. Pin bones 115B, approximately 30 total, are positioned wholly within the loin 220B, rather than being positioned between the belly 230B and loin 220B and extend in a straight line from the anterior or foremost portion of the fish fillet (i.e., from the neck 210B) to the posterior or hindmost portion and ending before the tail 240B of the fish fillet.

Connective tissue (CT) attaches pin bones directly to muscle tissue and tendons in cod. In salmon, pin bones are embedded in a layer of adipose tissue before epitaxial muscle tissue. The makeup of the attachment site, e.g., collagens, elastin, fibrous and lectin-binding proteins, proteoglycans, glycosaminoglycans (GAGs), blood vessel, nerves, etc., differ between salmon and cod. The chemical composition and microstructure of CT differs in salmon versus cod. CT in cod is more resistant to enzymatic degradation compared to the CT in salmon. Additionally, the structure differences between the attachment sites of the pin bones and other muscle tissues are limited in salmon, whereas in cod, substantial variances are understood to exist in structure, metabolism and cell processes between the pin bone attachment site and muscle elsewhere. In short, the attachment of the pin bones in cod and salmon is different, so the methods for loosening the attachment of the pin bones to the flesh and subsequently removing the pin bones may differ depending on the type of fish. Although the description herein refers to salmon and cod, embodiments of the invention may be applied to other fish, such as whitefish, for example, halibut.

The CT in fish is heat-labile and denatures at lower temperatures than CT in land animals. Studies of the thermal properties of collagen, a common protein in CT, suggest a thermal transition of cod collagen appears as a small peak in the endothermic heat flow at approximately 86 degrees Fahrenheit and a stronger peak at approximately 104 degrees Fahrenheit. In comparison, the thermal transition of salmon collagen appears as a single strong peak in the range of approximately 110-115 degrees Fahrenheit. These studies indicate that mild heating weakens the attachments of pin bones to the muscle. However, heating the whole fillet would result in a very poor product and the heating therefore needs to be limited to the area directly and immediately surrounding the pin bone, for example, according to the embodiments of the invention described herein.

In chemistry, the lability of a compound pertains to the capability of that substance to undergo a change. Thus, the term heat-labile describes the capability of changing or destroying the compound when subjected to heat. In biochemistry, a molecule that is heat-labile means it can exist transiently in a particular conformation by means of heat before assuming a lower energy or stable conformation. In another context, a heat-labile molecule means it can also be destroyed upon exposure at high temperatures. For instance, a heat-labile protein, such as collagen, may lose its structure as it is exposed to higher temperatures.

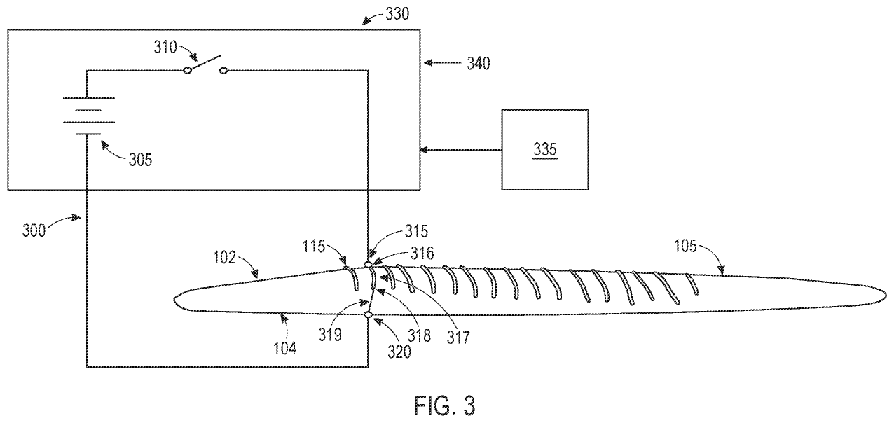

FIG. 3 illustrates an embodiment of the invention. The illustrated apparatus 300 weakens the attachment of a pin bone 115 to muscle or adipose tissue 317 in a fillet of fish 105. The apparatus comprises a power supply 305 and an electrode 315 coupled to the power supply and in electrical contact with a first end 316 of a pin bone 115 to conduct electrical current from the power supply to the pin bone 115. The pin bone 115 acts as a conductor to conduct the electrical current from the first end 316 of the pin bone 115 to a second end 318 of the pin bone 115. The pin bone 115 has an electrical current resistivity which causes Joule heating (the process by which the passage of an electric current through a conductor produces heat, which is also known as resistive, resistance, or Ohmic, heating). The conversion of electricity to heat in the pin bone 115, by virtue of its electrical resistance, allows the pin bone 115 to be used essentially as a heating element, according to embodiments of the invention. The Joule heating produces sufficient heat in the connective tissue that attaches the pin bone 115 to the muscle or adipose tissue 317 in the fillet of fish 105 to degrade or denature the connective tissue and thereby weaken the attachment of the pin bone 115 to the muscle or adipose tissue 317 in the fillet of fish 105. A grounding electrode 320 couples to the power supply 305 and is in electrical contact with the fillet of fish 105, for example, in electrical contact with an outside, or skin, surface of the fillet of fish 105, to return the electrical current to the power supply 305 or to ground.

FIG. 3 illustrates the apparatus 300 in use with a salmon fillet of fish. However, it is appreciated that the apparatus may be used with other fish, including fin fish such as cod and halibut. Moreover, the apparatus may be used in conjunction with fresh fish, whether in a pre-rigor mortis or post-rigor mortis state. Indeed, the main benefit of using the apparatus 300 on fresh, as opposed to decayed, fish is that the pin bones, once their attachment to the muscle or adipose tissue in the fillet of fish is weakened or loosened according to embodiments of the invention, can be removed in a subsequent step in processing with little to no damage or tearing of the flesh in a fresh fish, which is not possible with current industry equipment and processes.

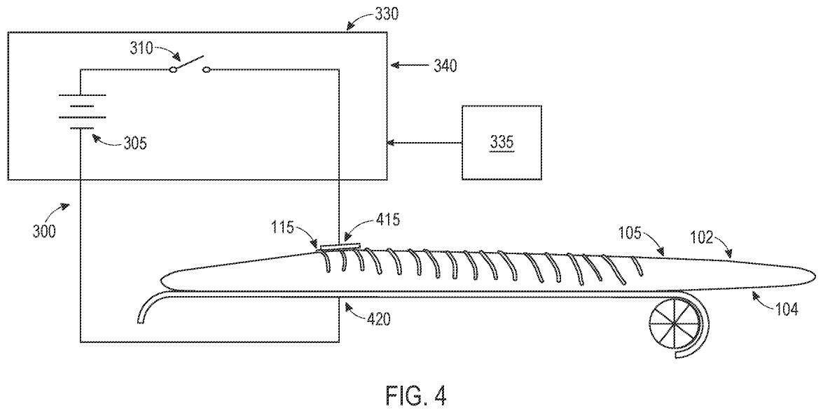

FIG. 3 illustrates apparatus 300 having a generic power supply 305. It is appreciated that the power supply may supply an alternating current (AC), a direct current (DC), a rectified current, a pulsed direct electrical current, a half-wave rectified electrical current, and a full-wave rectified electrical current, so long as sufficient current is applied for sufficient time intervals and at the appropriate length of time to the pin bones in a fillet of fish. For example, with reference to FIG. 4, if the fillet of fish is moving past the apparatus 300 while on a conveyor belt 420 at a given speed, the amplitude and phase of the electrical current is shaped accordingly to provide adequate electrical current at the precise time and for an adequate period of time to each pin bone 115 that electrode 315 comes into electrical contact with, so as to weaken the attachment of the pin bones to the muscle or adipose tissue of the fillet of fish.

In one embodiment, as illustrated in FIG. 4, the electrode 415 is plate is shaped and of sufficient length and positioned to come into concurrent contact with multiple pin bones. In such an embodiment, extended and/or multiple periods or pulses of electrical current may be received and conducted by each pin bone while in contact with the plate.

According to embodiments of the invention, the electrode 315, 415 is in electrical contact with the first end of the pin bone to conduct electrical current from the power supply to the pin bone. According to other embodiments of the invention, the electrode is in actual physical contact with an exposed first end of the pin bone. Often, the pin bone is exposed as part of the process of filleting the fish and removing the backbone, so bringing the electrode in physical contact with the pin bone is a relatively straightforward mechanical process. However, sometimes, the first end or tip of the pin bone is located right at, or just below, the inside, or muscle, surface of the fillet of fish. In such cases, it may be advantageous to bend backward the fillet of fish to thrust and expose the first end of the pin bone from, or just below, the inside surface of the fillet. This may be accomplished, for example, with reference to FIG. 4, by placing an elevated roller or rail or plate (not shown) under a conveyor belt 420 on which the fillet fish is positioned such that as the conveyor belt travels over the elevated roller or rail or plate, the fillet of fish is bent backwards thereby exposing or better exposing the first end of the pin bone at or near the inside surface of the fillet of fish.

The pin bones in a fillet of fish may extend from the inside surface 102 of the fillet to, or nearly to, the skin, or outside, surface 104 of the fillet of fish 105. In such cases, the pin bone 115 conducts the electrical current from the first end 316 of the pin bone to the second end 318 of the pin bone and, thus, to or near the outside surface 104 of the fillet of fish 105. There, the grounding electrode is in electrical contact with the second end of the pin bone and the outside, or skin, surface of the fillet of fish, and, thus, the electrical current is returned to the power supply or to ground. However, in some cases, one or more of the pin bones in a fillet of fish may not extend to, or nearly to, the skin, or outside, surface 104 of the fillet of fish 105. In such cases, the muscle tissue 317 of the fillet of fish 105 conducts the electrical current across a fleshy gap between the second end 318 of the pin bone 115 and the outside surface 104 of the fillet of fish 105, as depicted by the dotted line 319 in FIG. 3. There, the grounding electrode 320 is in electrical contact with the outside, or skin, surface 104 of the fillet of fish 105, and, thus, the electrical current is returned to the power supply 305 or to ground.

In some embodiments, the grounding electrode is in actual physical contact with the fillet of fish to return the electrical current to the power supply or to ground. For example, a conveyor belt 420 on which the fillet of fish is positioned may be grounded or include an embedded conductor, e.g., a metal wire, that is grounded. Alternatively, a rotating roller or ball, or a stationary pin, rail or plate positioned as electrode 320, around (i.e., under or below) which a conveyor belt is routed, comes into physical contact with the skin, or outside, surface 104 of the fillet of fish 105 to return the electrical current to the power supply or to ground.

An embodiment of the invention may include a controller 330 coupled to the power supply 305 to select an amount of the electrical current conducted from the power supply 305 to the pin bone 115. According to the embodiment, the pin bone conducts the selected amount of electrical current such that the resulting Joule heating produces sufficient heat to degrade or denature the connective tissue encompassing or substantially encompassing the pin bone and thereby weakening the attachment of the pin bone to the muscle or adipose tissue in the fillet of fish without degrading or denaturing the muscle or adipose tissue. According to this embodiment, the controller may control a switch 310 that opens or closes, for example, according to selected on/off duty cycle, to control the timing and/or shape (i.e., amplitude, or pulse height, and duration, or pulse width) of the electrical current applied to the fillet of fish.

According to an embodiment, the controller 330 selects the amount of electrical current conducted from the power supply 305 to the pin bone 115 based on one or more of a number of factors, including, but not limited to, pre- versus post-rigor condition of the fillet of fish, skinned versus unskinned fillet of fish, size of the fillet of fish, thickness of the fillet of fish, estimated age of the fish, size(s) of the pin bone, location of pin bone in the fillet of fish (e.g., from a foremost (near the neck 210A) versus a hindmost (near the tail 240A) location), type of fish, time elapsed since harvest of the fillet of fish, temperature of the fillet of fish, time elapsed since filleting the fish, electrical resistivity of the pin bone, amount of Joule heating in the pin bone, composition of the connective tissue that attaches the pin bone to the muscle or adipose tissue of the fillet of fish, and combinations thereof In this regard, any number and types of sensors or equipment 335 may be used to gather information and data related to these factors, such as cameras, machine vision equipment, x-ray machines, magnetic resonance imaging equipment, heat sensors, weight sensors, tissue sampling equipment, etc. Additionally, user input 340 may be provided as to which factors to consider and the values of data or information relating to those factors to consider in determining the amount and/or timing of electrical current to be applied.

In another embodiment, the controller 330 is coupled to an energy source to select an amount of energy applied to the pin bone 115. According to the embodiment, the pin bone receives the selected amount of heat such that the resulting heating of the pin bone produces sufficient heat to degrade or denature the connective tissue encompassing or substantially encompassing the pin bone and thereby weakening the attachment of the pin bone to the muscle or adipose tissue in the fillet of fish without degrading or denaturing the muscle or adipose tissue. According to this embodiment, the controller may control a switch 310 that opens or closes, for example, according to a selected on/off duty cycle, to control the timing and/or shape (i.e., amplitude, or pulse height, and duration, or pulse width) of the energy applied to the fillet of fish.

It is appreciated that the above-described method and apparatus can be implemented as a stand-alone piece of equipment or machine. The equipment or machine may be installed in a fish processing facility, after a filleting machine and before a pin-bone removal machine, connected to each via one or more conveyor belts or rollers, and over which the fillets of fish travel from one station or machine to another in the processing facility. It is further appreciated that the method and apparatus could be integrated into other equipment, such as a pin bone removal machine, wherein an existing component such as a rotating drum may be used as the electrode 315, and a conveyor belt or roller or other component associated therewith may be used as the grounding electrode 320.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims that follow. Features of the disclosed embodiments can be combined and rearranged in various ways.

What is claimed is:

1. An apparatus for weakening an attachment of a pin bone to muscle or adipose tissue in a fillet of fish, comprising:
an energy source to supply sufficient heat to substantially only the pin bone and connective tissue that attaches the pin bone to the muscle or adipose tissue in the fillet of fish to degrade or denature the connective tissue without degrading or denaturing the muscle or adipose tissue and thereby weaken the attachment of the pin bone to the muscle or adipose tissue in the fillet of fish.

2. The apparatus of claim 1, wherein the fillet of fish is selected from a group consisting of:
salmon, cod, and halibut, whether pre-rigor mortis or post-rigor mortis.

3. The apparatus of claim 1, wherein the energy source is selected from a group consisting of:
microwaves, audio waves, X-rays, laser, tailored photon bombardment, and neutron bombardment.

4. The apparatus of claim 1 further comprising a controller coupled to the power supply to select an amount of the electrical current conducted from the power supply to the pin bone, wherein the pin bone conducting the electrical current from the first end of the pin bone to the second end of the pin bone comprises the pin bone conducting the selected amount of electrical current from the first end of the pin bone to the second end of the pin bone such that the Ohmic heating produces sufficient heat in substantially only the connective tissue that attaches the pin bone to the muscle or adipose tissue in the fillet of fish to degrade or denature the connective tissue without degrading or denaturing the muscle or adipose tissue and thereby weaken the attachment of the pin bone to the muscle or adipose tissue in the fillet of fish.

5. The apparatus of claim 4, wherein the controller selects the amount of electrical current conducted from the power supply to the pin bone based on factors selected from a group consisting of: a pre-rigor condition of the fillet of fish, a post-rigor condition of the fillet of fish, a skinned versus unskinned fillet of fish, a size of the fillet of fish, a thickness of the fillet of fish, an estimated age of the fish, a size of the pin bone, a location of pin bone in the fillet of fish, a type of fish, an estimated time elapsed since harvest of the fillet of fish, an estimated time elapsed since filleting the fish, an electrical resistivity of the pin bone, an amount of joule heating in the pin bone, and combinations thereof.

6. A method for weakening an attachment of a pin bone to muscle or adipose tissue in a fillet of fish, comprising:
applying heat to the pin bone; and
conducting the applied heat along the pin bone sufficient to heat the pin bone and substantially only connective tissue that attaches the pin bone to the muscle or adipose tissue in the fillet of fish to degrade or denature the connective tissue without degrading or denaturing the muscle or adipose tissue and thereby weaken the attachment of the pin bone to the muscle or adipose tissue in the fillet of fish.
